(19) United States
(12) Patent Application Publication
(10) Pub. No.: US 2009/0081107 A1
(43) Pub. Date: Mar. 26, 2009

(54) Protective barrier for poles, posts, and timbers composed of self-fusing silicone

(76) Inventor: Benjamin Alan Abbott, Humphrey, NE (US)

Correspondence Address: BENJAMIN ABBOTT, 41674 261 AVE., HUMPHREY, NE, 68642, US

(21) Appl. No.: 11/904,054

(22) Filed: Sep. 26, 2007

(51) Int. Cl. C01B 33/02

(52) U.S. Cl. 423/348

(57) ABSTRACT

This invention is the utilization of self-fusing silicone to create a continuous protective barrier for wood or composite poles, posts, or similar structures. The insulating properties of silicone will provide some fire protection, while the self-fusing characteristic of the material will create a completely sealed barrier. This protective silicone layer may be used over a primary layer with different properties to achieve a barrier with more target specific characteristics.

### FIELD OF INVENTION

This invention is for the field of wood and forest products protection.

### BACKGROUND OF INVENTION

In the field of wood protection the use of protective barriers to aid in resisting biological degradation is well established art. The existing systems are mostly based on an organic material such as polyethylene being installed around the pole. These systems however frequently either do not provide a continuously sealed barrier or require special equipment for installation.

### BRIEF SUMMARY OF INVENTION

This invention is the application of self-fusing silicone as a continuous barrier to protect poles, posts, and similar structures.

### DETAILED DESCRIPTION OF THE INVENTION

This invention is the application of self-fusing silicone tape as a continuous protective barrier for poles, posts, or similar structures. The barrier will be applied before or after setting in ground, cement, or similar settings. The silicone then fuses to itself providing an environmental barrier. From slightly above ground line to anywhere from one foot below ground to the entire below ground section of the structure the barrier will reduce and retard the out migration and depletion of wood preservatives from preservative treated wood and provide protection from biological decay factors common in that region including termites, fungi, and others. If extended above ground line the silicone barrier will provide environmental protection from fire damage. By utilizing self fusing silicone the need for mechanical or chemical sealants will be eliminated. The barrier may also include a primary contact barrier such as but not limited to nylon saran, copper foil, biologically active material, or other metal foils to impart other desired trait such as a gas exchange or biologically active barrier.

1. What I claim is that my invention is the application of self-fusing silicone as a protective barrier for poles, posts, and similar structures, to protect from biological degradation.
A dependant claim is that said barrier would prevent migration of treating chemical away from structure, thereby reducing environmental impact as well as retaining more of the chemicals in the target material.

2. What I claim is the use of self-fusing silicone with or without a separate primary contact layer as a means of fire protection.

3. What I claim is a self-fusing silicone barrier that may be used over a primary barrier as a two part system to achieve a target specific barrier.
